(19) United States
(12) Patent Application Publication
(10) Pub. No.: US 2013/0026161 A1
(43) Pub. Date: Jan. 31, 2013

(54) WATERTIGHT PACKING STRUCTURE OF ELECTRICAL JUNCTION BOX

(71) Applicants: Sunsoku I, Makinohara-Shi (JP); Masahiro Akahori, Makinohara-shi (JP)

(72) Inventors: Sunsoku I, Makinohara-Shi (JP); Masahiro Akahori, Makinohara-shi (JP)

(73) Assignee: Yazaki Corporation, Tokyo (JP)

(21) Appl. No.: 13/559,642

(22) Filed: Jul. 27, 2012

(30) Foreign Application Priority Data
Jul. 28, 2011 (JP) 2011-165206

(51) Int. Cl. H02G 3/08

(52) U.S. Cl. 220/3.8

(57) ABSTRACT

A watertight packing structure of an electrical junction box includes: a box main body; a cover; inclined step portions each formed on the box main body and the cover; a packing-receiving groove provided on any one of the step portions; and a wall-end portion provided on the other step portion for pushing a packing in the packing-receiving groove. At a start end or a stop end of the step portion, a gap between the most concaved portion in a concave curved portion of any one of the packing-receiving groove and the wall-end portion facing each other and the most projecting portion in a convex curved portion of the other is set narrower than any other gap between any other portions of both curved portions. A radius R₁ of the concave curved portion is set larger than a radius R₂ of the convex curved portion.

### CROSS REFERENCE TO RELATED APPLICATIONS

This application is on the basis of Japanese Patent Application No. 2011-165206, the contents of which are hereby incorporated by reference.

### BACKGROUND OF THE INVENTION

1. Technical Field

The present invention relates to a watertight packing structure of an electrical junction box mounted on a vehicle or the like for making a space between step portions of both covers of the electrical junction box watertight.

2. Background Art

Conventionally, various watertight packing structures of an electrical junction box mounted on a vehicle or the like are proposed for preventing water from entering the electrical junction box via a space between a box main body and a cover of the electrical junction box.

For example, in PTL 1, it is described that upper and lower covers are respectively attached to an upper side and a lower side of an electric-component-mounting block (box main body). The lower cover has a notch for mounting a grommet. A watertight packing is placed between the electric-component-mounting block and the lower cover so as to be closely attached to the grommet.

Further, in PTL 2, it is described that in a space between a housing main body (box main body) and an upper housing cover (cover), a packing is compressed and placed between an upper peripheral wall of the housing main body and a concave of the housing cover.

Further, in PTL 3, it is described that a rubber-made O-ring is placed between a case main body (box main body) and a case cover (cover).

Further, in PTL 4, it is described that though a packing is not used, a inclined step portion is formed on a part of a periphery of an upper case (cover) and an under case (box main body), and matching surfaces changing from horizontal to inclined of both cases are closely attached to each other for making them watertight.

### CITATION LIST

### Patent Literature

Patent Literature 1: JP, A, 2001-251724

Patent Literature 2: JP, A, H11-346064

Patent Literature 3: JP, A, 2005-129807

Patent Literature 4: JP, A, 2008-61415

### SUMMARY OF INVENTION

### Technical Problem

However, in the above conventional watertight packing structure of an electrical junction box, for example, in a case that the inclined step portion is formed on the box main body and the cover as shown in PTL 4, when a packing, in particular, foamable packing is placed along the inclined step portion, the packing is pulled in a longitudinal direction along a curve at a start end side or a stop end side of the inclined step portion to reduce a thickness of the packing, and there is a fear that an adhesion property to the step portion, namely, watertight property may be reduced.

In view of the above, an object of the present invention is to provide a watertight packing structure of an electrical junction box able to prevent an adhesion property of the packing, namely, a watertight property at a start end and a stop end of a step portion from being reduced when an elastic packing is placed along an inclined step portion formed on a box main body and a cover.

### Solution to Problem

For achieving the object, according to a first aspect of the present invention, there is provided a watertight packing structure of an electrical junction box including:

a box main body;

a cover;

inclined step portions each formed on the box main body and the cover;

a packing-receiving groove provided on any one of the step portions; and

a wall-end portion provided on the other step portion for pushing a packing in the packing-receiving groove,

wherein at a start end or a stop end of the step portion, a gap between the most concaved portion in a concave curved portion of any one of the packing-receiving groove and the wall-end portion facing each other and the most projecting portion in a convex curved portion of the other is set narrower than any other gap between any other portions of both curved portions.

According to the above, for one example, a concave curved portion is provided on the wall-end portion at a lower end of an upper inclined step portion of the box main body, and a convex curved portion is provided on the packing-receiving groove at a lower end of an upper inclined step portion of the cover facing the concave curved portion (a bottom wall of the packing-receiving groove is curved in a convex shape). While the cover is placed on an upper side of the box main body, the concave curved portion of the wall-end portion of the box main body enters the packing-receiving groove of the cover to compress the packing. Even though the packing is pulled along the convex curved portion to be thin, and placed in the packing-receiving groove, a thinned portion (a generated gap) is filled with a narrow gap between the most concaved portion of the concave curved portion and the most projecting portion of the convex curved portion, thereby the packing is elastically and closely attached to the concave curved portion without a gap. Thereby, a watertight sealing property is properly secured.

For another example, when the cover is placed on a lower side of the box main body, the concave curved portion is provided on the wall-end portion of the cover at a lower end of the upper inclined step portion of the cover, and the convex curved portion is provided on the packing-receiving groove of the box main body at a lower end of the lower inclined step portion of the box main body facing the concave curved portion (a bottom wall of the packing-receiving groove is curved in a convex shape). While the cover is placed on a lower side of the box main body, the concave curved portion of the wall-end portion of the cover enters the packing-receiving groove of the box main body to compress the packing. Even though the packing is pulled along the convex curved portion to be thin, and placed in the packing-receiving groove, a thinned portion (a generated gap) is filled with a narrow gap between the most concaved portion of the concave curved portion and the most projecting portion of the convex curved portion, thereby the packing is elastically and closely attached to the concave curved portion without a gap. Thereby, a watertight sealing property is properly secured.

According to a second aspect of the present invention, there is provided the watertight packing structure of an electrical junction box as described in the first aspect,

wherein a radius of the concave curved portion is set larger than a radius of the convex curved portion, and a bend center of the concave curved portion is offset in a direction of compressing the packing from a bend center of the convex curved portion.

According to the above, for example, a concave curved portion is provided on the wall-end portion at a lower end of an upper inclined step portion of the box main body, and a convex curved portion is provided on the packing-receiving groove at a lower end of an upper inclined step portion of the cover facing the concave curved portion (a bottom wall of the packing-receiving groove is curved in a convex shape). While the cover is placed on an upper side of the box main body, the concave curved portion of the wall-end portion of the box main body enters the packing-receiving groove of the cover to compress the packing. Even though the packing is pulled along the convex curved portion to be thin, and placed in the packing-receiving groove, a thinned portion (a generated gap) is filled with the concave curved portion having a larger radius and offset in the direction of compressing the packing, thereby the packing is elastically and closely attached to the concave curved portion without a gap. Thereby, a watertight sealing property is properly secured.

According to a third aspect of the present invention, there is provided the watertight packing structure of an electrical junction box as described in the first or second aspect,

wherein the concave curved portion is provided on the wall-end portion of the lower inclined step portion of the box main body, and the convex curved portion is provided on the packing-receiving groove of the inclined step portion of the cover placed on an upper side of the box main body.

According to the above, for example, a concave curved portion is provided on the wall-end portion at a lower end of an inclined step portion of the box main body, and a convex curved portion is provided on the packing-receiving groove at a lower end of an inclined step portion of the cover facing the concave curved portion (a bottom wall of the packing-receiving groove is curved in a convex shape). While the cover is placed on an upper side of the box main body, the concave curved portion of the wall-end portion enters the packing-receiving groove to compress the packing. Even though the packing is pulled along the convex curved portion to be thin, and placed in the packing-receiving groove, a thinned portion (a generated gap) is filled with a narrow gap between the most concaved portion of the concave curved portion and the most projecting portion of the convex curved portion, or the concave curved portion having a larger radius and offset in the direction of compressing the packing, thereby the packing is elastically and closely attached to the concave curved portion without a gap. Thereby, a watertight sealing property is properly secured.

### Advantageous Effects of Invention

According to the first aspect of the present invention, when the elastic packing is placed along the inclined step portions each formed on the box main body and the cover, even while the packing is pulled along the convex curved portion at the start end or the stop end of the step portion, the reduction of the thickness of the packing is compensated by the narrow gap between the most concaved portion of the concave curved portion and the most projecting portion of the convex curved portion, thereby the packing is closely attached to the concave curved portion without a gap. Therefore, an adhesion property, namely, a watertight property of the packing is prevented from being reduced. Therefore, even when the water is poured vigorously over the electrical junction box, the water is surely prevented from entering the electrical junction box.

According to the second aspect of the present invention, when the elastic packing is placed along the inclined step portions each formed on the box main body and the cover, even while the packing is pulled along the convex curved portion at the start end or the stop end of the step portion, the reduction of the thickness of the packing is compensated by the concave curved portion having a larger radius and offset in the direction of compressing the packing, thereby the packing is closely attached to the concave curved portion without a gap. Therefore, an adhesion property, namely, a watertight property of the packing is prevented from being reduced. Therefore, even when the water is poured vigorously over the electrical junction box, the water is surely prevented from entering the electrical junction box.

According to the third aspect of the present invention, while the packing placed on the packing-receiving groove of the cover is protected in the cover, the cover is attached to the electrical junction box from the above. Therefore, the water pressure is prevented from being applied directly to the packing, thereby the watertight property is improved.

These and other objects, features, and advantages of the present invention will become more apparent upon reading of the following detailed description along with the accompanied drawings.

### BRIEF DESCRIPTION OF DRAWINGS

FIG. 1 is an exploded perspective view showing an embodiment of a watertight packing structure of an electrical junction box according to the present invention;

FIG. 2 is a perspective view showing a main part of a lower cover of the electrical junction box;

FIG. 3 is a front view showing a main part of the lower cover;

FIG. 4 is a vertical sectional view showing a main part of a state that an upper cover with a packing is placed on the lower cover;

FIG. 5A is a vertical sectional view showing a main part of a conventional packing compressed by both covers;

FIG. 5B is a vertical sectional view showing a main part of a packing compressed by both covers according to the present invention corresponding to ‘A’ in FIG. 4;

FIG. 6 is a perspective view showing an inside of the upper cover; and

FIG. 7 is a perspective view showing a main part of the upper cover.

### DESCRIPTION OF EMBODIMENTS

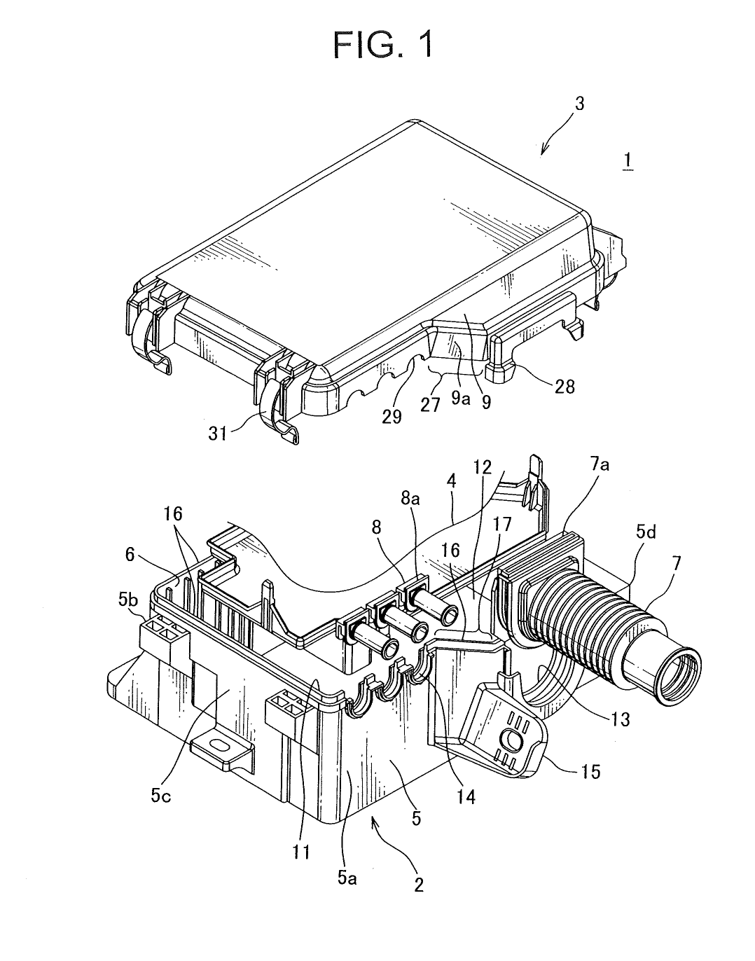

FIGS. 1 to 7 show an embodiment of a watertight packing structure of an electrical junction box according to the present invention.

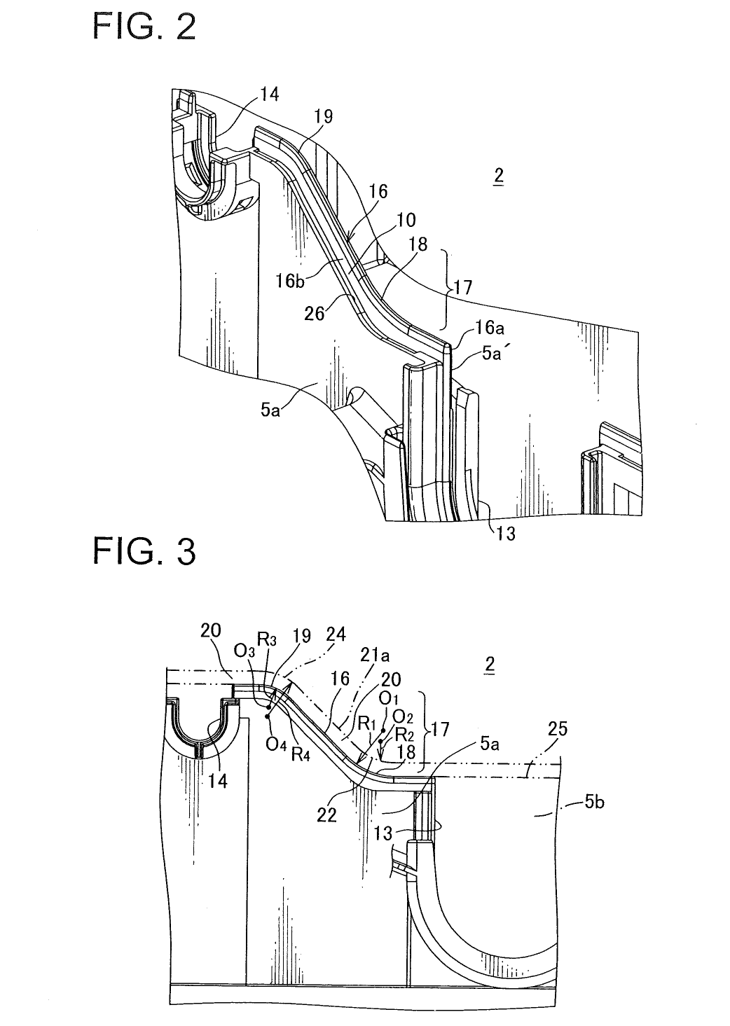

As shown in FIG. 1, this electrical junction box 1 includes: a synthetic-resin-made deep lower cover (box main body) 2; a not-shown block connecting body placed and fixed in a state to be put on a tray 4 in the lower cover 2; a synthetic-resin-made shallow upper cover (cover) 3 covering an upper opening 6 of the lower cover 2 by fitting with an upper side of a peripheral wall 5 of the lower cover 2; rubber-made large and small watertight grommets 7, 8 placed between the lower cover 2 and the upper cover 3; a not-shown elastic packing placed in a packing-receiving groove 10 (FIG. 2) disposed inside of a peripheral wall 9 of the upper cover 3, and closely attached to upper faces 7a, 8a of the grommets 7, 8 and to an upper end portion 11 of the peripheral wall 5 of the lower cover 2.

The lower cover 2 includes: a horizontal bottom wall 12; and the peripheral wall 5 composed of four vertical sidewalls 5a to 5d; notch openings 13, 14 provided on the front sidewall 5a for placing the large and small grommets 7, 8; and brackets 15 provided on front and rear sidewalls for attaching to a vehicle body.

In the not-shown block connecting body, electric components such as relay and fuse are placed on an upper side of an insulating-resin-made block main body, and electric wires connected to the electric components and bus bars in the block main body with terminals are guided out via the grommets 7, 8.

As shown in FIGS. 2 and 3, an upper end portion (wall-end portion) 16 at a left side of the sidewall 5a is inclined right-side down toward a large notch opening 13 of the front sidewall 5a of the lower cover 2 to form a step portion 17. An arc-shaped concave curved portion 18 having a large bend radius is formed at a lower side (near the large notch opening 13) of the inclined upper end portion 16. An arc-shaped convex curved portion 19 having a small bend radius is formed at an upper side (near the small notch opening 14) of the inclined upper end portion 16.

The inclined step portion 17 contributes to dispose the large grommet 7 (FIG. 1) near the bottom wall 12 of the lower cover 2, and to improve attaching and detaching ability of the electric components by exposing the large electric components such as relay at an upper side of the not-shown block connecting body.

As shown in FIG. 3, the concave curved portion 18 having a large bend radius has a virtual bend center O₁ at an upper side thereof. The convex curved portion 19 having a small bend radius has a virtual bend center O₃ at a lower side thereof. A feature of this embodiment is that a radius R₁ of the concave curved portion 18 of the lower cover 2 and a position of its bend center O₁ are changed with respect to conventional ones.

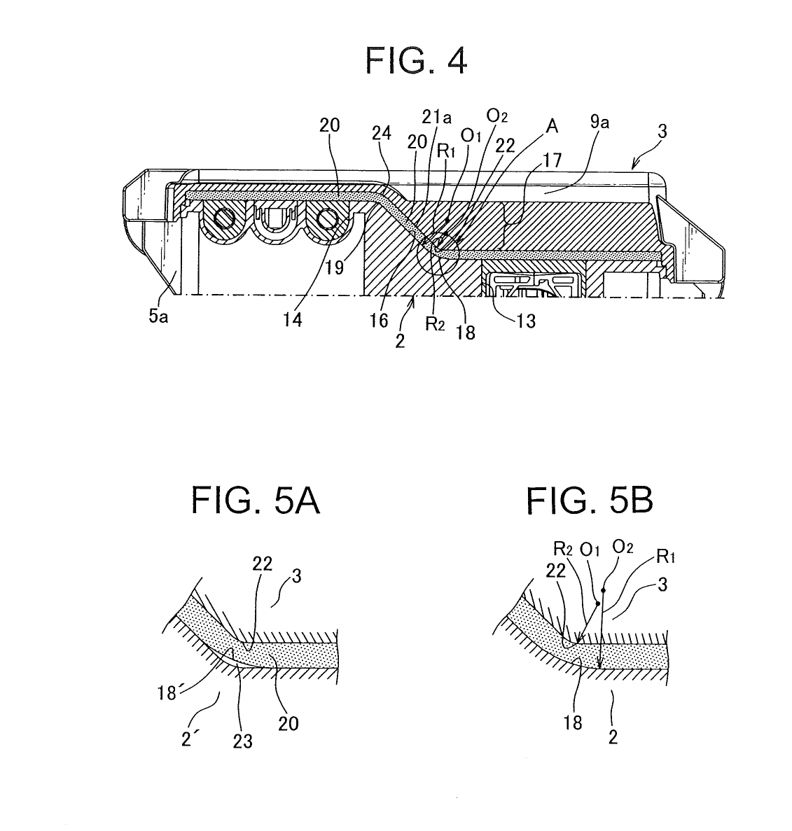

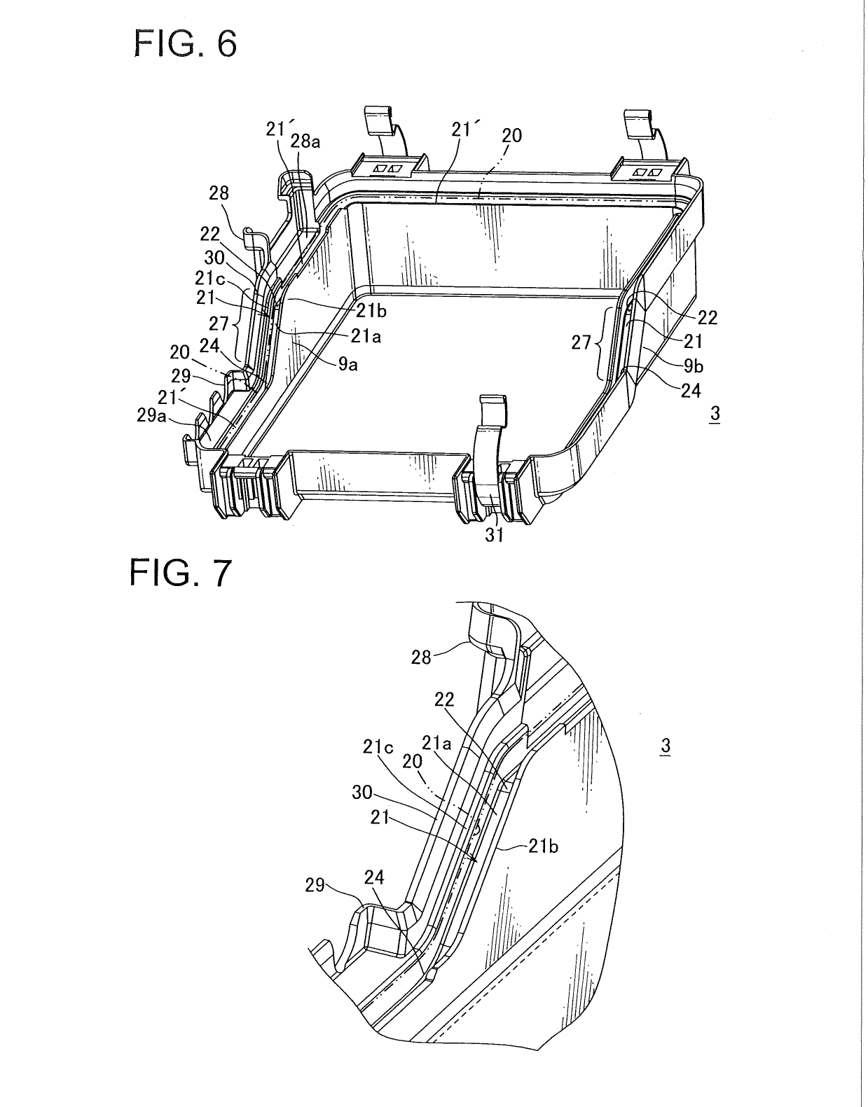

Namely, as shown in FIG. 3 (see a portion denoted by a virtual line) and in FIG. 4, the packing 20 is arranged at an upper side of the upper end portion 16 of the sidewall 5a of the lower cover 2, and a bottom face 21a of the packing-receiving groove 21 of the sidewall 9a of the upper cover 3 (FIG. 6) is arranged at an upper side of the packing 20. The radius R₁ of the large concave curved portion 18 of the lower cover 2 is set larger than a radius R₂ of the convex curved portion 22 of the bottom face 21a of the packing-receiving groove 21 of the upper cover 3. In addition, the bend center O₁ of the radius R1 of the large concave curved portion 18 is positioned upper than a bend center O2 of the radius R2 of the convex curved portion 22 of the bottom face 21a of the packing-receiving groove 21, namely, positioned in a direction compressing the packing 20.

Thereby, as shown in FIG. 5A, conventionally, the packing 20 is pulled and extended along the convex curved portion 22 in between the upper cover 3 and a conventional lower cover 2′, in particular, a thickness of the packing 20 is reduced at a top of the convex curved portion 22 of the upper cover 3, and a gap 23 is generated between the packing 20 and the lower cover 2′. Therefore, there is a problem that the water may enter the electrical junction box via the gap 23. However, according to this embodiment, the problem is solved.

Namely, as shown in FIG. 5B which is an enlarged view of ‘A’ in FIG. 4, the radius R₁ of the concave curved portion 18 (namely, the upper end portion 16 of the sidewall 5a) of the lower cover 2 is set larger than the radius R₂ of the convex curved portion 22 (namely, the curved bottom face 21a of the packing-receiving groove 21) of the upper cover 3. In addition, the bend center O₁ of the radius R1 of the large concave curved portion 18 is offset upper than a bend center O2 of the radius R2 of the convex curved portion 22 of the bottom face 21a of the packing-receiving groove 21, namely, offset in a direction compressing the packing 20 (see FIG. 3). Thereby, the gap 23 between the packing 20 and the lower cover 2′ disappears and the packing 20 is surely pressed by the concave curved portion 18 having a large radius of the lower cover 2. Therefore, an upper and lower faces of the packing 20 is surely closely attached to the concave curved portion 18 and the convex curved portion 22, and watertight property is improved.

A similar relationship can be applied to the convex curved portion 19 at an upper side (left side) of the inclined upper end portion 16 of the lower cover 2 and a concave curved portion 24 of the packing-receiving groove 21 of the upper cover 3 (curved bottom face 21a) in a left side of FIGS. 3 and 4. Namely, a radius R₃ of the convex curved portion 19 of the lower cover 2 is set small, and a radius R₄ of the concave curved portion 24 of the packing-receiving groove 21 of the upper cover 3 is set large. In addition, a bend center O₄ of the radius R₄ of the concave curved portion 24 is offset lower than a bend center O₃ of the radius R₃ of the convex curved portion 19, namely, offset in a direction compressing the packing 20. Thereby, the similar effect as above is attained. However, in comparison with the convex curved portion 22, the packing 20 is not so pulled along the concave curved portion 24. Therefore, this effect is subsidiary.

Incidentally, when the packing-receiving groove (21) is provided on the lower cover 2, and a bottom end portion of the sidewall 9a of the upper cover 3 enters the packing-receiving groove (21), the packing 20 is pulled and extended along the convex curved portion (19) of the packing-receiving groove (21) of the lower cover 2. Therefore, a radius of the concave curved portion (24) at the lower end portion of the sidewall 9a of the upper cover 3 is set larger than a radius of the convex curved portion (19) of the lower cover 2, and the bend center (O₄) of the concave curved portion (24) is arranged lower than the bend center (O₃) of the convex curved portion (19), namely, arranged in a direction compressing the packing 20. Thereby, the similar effect as above is attained.

When summarizing a relationship among the curved portions 18, 19, 22, 24 shown in FIGS. 3 and 4, radii R₂, R₃ of the curved portions 19, 22 as an inside bend of the packing 20 are set small, and radii R₁, R₄ of the curved portion 18, 24 as an outside bend are set large. In addition, the bend centers O₁, O₄ of the curved portions 18, 24 bent outside are offset more inward than the bend centers O₂, O₃ of the curved portions 19, 22 bent inside.

For example, when the bend center O₂ of the curved portion 22 bent inside and the bend center O₁ of the curved portion 18 bent outside are arranged coaxially (only the radii R₁, R₂ are different from each other), because the gap between the curved portions 18, 22 is even, the partial reduction of thickness of the packing 20 caused by the pull of the packing 20 cannot be compensated.

Further, when the bend center O1 of the curved portion 18 bent outside is offset not more inward (a direction of compressing the packing 20) but more outward (an opposite direction of compressing the packing 20) than the bend center O2 of the curved portion 22 bent inside, because the gap between the curved portions 18, 22 is expanded, the above effect is not attained.

For example, in the conventional embodiment of FIG. 5A, a radius of the concave curved portion 18′ of the lower cover 2′ is about 18.1 mm, a thickness of the packing 20 is about 4.5 mm, and a crush amount of the packing 20 is about 1.8 mm. In the embodiment of FIG. 5B, the radius R₁ of the concave curved portion 18 of the lower cover 2 is about 20.8 mm. Because the radius is largely changed from 18.1 mm to 20.8 mm, if the packing 20 is pulled, at least 1.8 mm of the crush amount of the packing 20 is secured.

A horizontal line denoted by a chain line 25 of FIG. 3 indicates an upper end of a rear sidewall 5b facing the front sidewall 5a of the lower cover 2. In the rear sidewall 5b, the radii R₁, R₃ and the bend centers O₁, O₃ of the curved portions 18, 19 at the start end and the stop end of the inclined upper end portion 16 in the step portion 17 are set similar to the front sidewall 5a.

As shown in FIG. 2, a thickness of the inclined upper end portion 16 of the lower cover 2 is formed substantially half of a thickness of the sidewall 5a. An inner face 16a of the inclined upper end portion 16 is positioned on the same vertical plane as an inner face 5a′ of the sidewall 5a. An outer face 16b of the inclined upper end portion 16 is continued to an outer face (front face) of the sidewall 5a via a step-shaped groove wall 26.

The most inside vertical wall 21b (inside wall of the packing-receiving groove) of the upper cover 3 as shown in FIGS. 6 and 7 is engaged with the groove wall 26 of the lower cover 2 shown in FIG. 2. The inclined upper end portion 16 of the lower cover 2 enters the packing-receiving groove 21 at an outside of the most inside wall 21b of the upper cover 3 to push and compress the packing 20 in a thickness direction. Similarly, the upper end portion 16 of the whole periphery of the lower cover 2 other than the inclined upper end portion 16 enters the packing-receiving groove 21 to push and compress the packing 20 in a thickness direction.

The packing-receiving groove 21 has a substantially U-shaped vertical section and is composed of vertical outside and inside walls 21b, 21c parallel to each other, and a horizontal and partially inclined (at the step portion 27) bottom wall 21a. Inner faces of the walls 21a to 21c is closely attached to three outer faces of the rectangular sectional shaped packing 20. The packing 20 is formed in a continuous slim rectangular shape, expanded to a wire rectangular shape, and pushed into the packing-receiving groove 21, and then adhered to the bottom wall 21a of the packing-receiving groove 21 with adhesive. In FIGS. 6 and 7, an upper end (lower end when the upper cover 3 is closed) of the packing 20 is denoted by a chain line 20. In FIGS. 6 and 7, an upper end face of the packing 20 is positioned a little lower than the packing-receiving groove 21, or substantially the same plane as the packing-receiving groove 21.

The center in a width direction of the upper end wall (lower end wall when the upper cover 3 is closed) of the packing 20 in the packing-receiving groove 21 is pressed by the upper end portion 16 of the peripheral wall 5 of the lower cover 2, and closely attached to the upper end portion 16. One convex curved bottom face (curved portion) 22 of the inclined packing-receiving groove 21 is positioned near a substantially U-shaped receiving wall 28 for receiving an upper side of the large grommet 7 (FIG. 1). The other concave curved bottom face (curved portion) 24 of the inclined packing-receiving groove 21 is positioned near a semi-circular groove 29 receiving an upper half of the small grommet 8 (FIG. 1).

The inclined packing-receiving groove 21 is positioned in between horizontal packing-receiving grooves 21′ at one sidewall 9a of the upper cover 3. A width direction of each horizontal packing-receiving groove 21′ is arranged perpendicular to horizontal sidewalls 28a, 29a of grommet receiving portions 28, 29. The grommet receiving portions 28, 29 are integrally formed with a peripheral wall (sidewall) 30 outside of the packing-receiving groove 21 of the upper cover 3.

As shown in FIG. 6, the similar inclined packing-receiving groove 21 is provided on the other sidewall 9b facing the one sidewall 9a at a grommet placing side of the upper cover 3. The similar convex curved bottom face (curved portion) 22 is arranged at one side of the packing-receiving groove 21, and the similar concave curved bottom face (curved portion) 24 is arranged at the other side of the packing-receiving groove 21.

The upper cover 3 of this embodiment is closely attached and latched to the lower cover 2 with a metallic spring arm 31. The electrical junction box 1 (FIG. 1) including the both covers 2, 3 is arranged on a portion exposed outside such as an engine room or underfloor of a vehicle (including a truck).

Incidentally, in the above embodiment, the step portion 17 is provided on both covers 2, 3 at an angle of about 45 degrees. However, the angle of the step portion 17 is not limited to about 45 degrees. The position relationship of the radii R₁, R₂ and the bend center O₁, O₂ of the concave curved portion 18 and the convex curved portion 22 of the both covers 2, 3 can be applied to the step portion 17 at an angle of more than 45 degrees, up to 90 degrees.

For example, the pulling force is larger, the stretch is longer, and the thickness of the packing 20 is further reduced in 90 degrees than 45 degrees. However, for example, the radius R₁ of the concave curved portion 18 with respect to the convex curved portion 22 is further increased, or the bend center O₁ of the concave curved portion 18 is further offset in a direction of compressing the packing 20, thereby a crushing margin of the packing 20 can be secured.

Further, in the above embodiment, a space between the upper cover 3 and the lower cover 2 is made watertight with the packing 20. However, for example, the watertight packing structure of the above embodiment can be applied to an electrical junction box including the upper cover 3, a not-shown intermediate frame (box main body) or a block connecting body (box main body), and the lower cover (2) in which a space between the upper cover 3 and the intermediate frame or the block connecting body, or a space between the intermediate frame or the block connecting body and the lower cover (2) is made watertight with the packing 20.

Further, in the above embodiment, the packing-receiving groove 21 is provided on the upper cover 3, and the upper end portion 16 of the sidewall 5a of the lower cover 2 enters the packing-receiving groove 21. However, the packing-receiving groove (21) may be provided on a lower end of the intermediate frame or the block connecting body, and the upper end portion 16 of the sidewall 5a of the lower cover 2 may enter the packing-receiving groove (21).

### INDUSTRIAL APPLICABILITY

The watertight packing structure of an electrical junction box according to the present invention can be used in an electrical junction box mounted on such as an outside of a body of a truck and exposed outside of the body to prevent the water bounced to the electrical junction box or the high-pressure cleaning water from entering the electrical junction box by increasing the watertight packing property at a inclined step portion between a box main body and a cover.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

### REFERENCE SIGNS LIST

1 electrical junction box

2 lower cover

3 cover (upper cover)

16 upper end portion (wall-end portion)

17, 27 step portion

18 concave curved portion

21 packing-receiving groove

20 packing

22 convex curved portion

R₁, R₂ radius

O₁, O₂ bend center

What is claimed is:

1. A watertight packing structure of an electrical junction box comprising:
a box main body;
a cover;
inclined step portions each formed on the box main body and the cover;
a packing-receiving groove provided on any one of the step portions; and
a wall-end portion provided on the other step portion for pushing a packing in the packing-receiving groove,
wherein at a start end or a stop end of the step portion, a gap between the most concaved portion in a concave curved portion of any one of the packing-receiving groove and the wall-end portion facing each other and the most projecting portion in a convex curved portion of the other is set narrower than any other gap between any other portions of both curved portions.

2. The watertight packing structure of an electrical junction box as claimed in claim 1,
wherein a radius of the concave curved portion is set larger than a radius of the convex curved portion, and a bend center of the concave curved portion is offset in a direction of compressing the packing from a bend center of the convex curved portion.

3. The watertight packing structure of an electrical junction box as claimed in claim 1,
wherein the concave curved portion is provided on the wall-end portion of the lower inclined step portion of the box main body, and the convex curved portion is provided on the packing-receiving groove of the inclined step portion of the cover placed on an upper side of the box main body.

4. The watertight packing structure of an electrical junction box as claimed in claim 2,
wherein the concave curved portion is provided on the wall-end portion of the lower inclined step portion of the box main body, and the convex curved portion is provided on the packing-receiving groove of the inclined step portion of the cover placed on an upper side of the box main body.
